(19) United States
(12) Patent Application Publication
(10) Pub. No.: US 2024/0340753 A1
(43) Pub. Date: Oct. 10, 2024

(54) METHOD AND APPARATUS FOR HANDOVER OF USER EQUIPMENT IN NES CELL IN A NEXT GENERATION MOBILE COMMUNICATION SYSTEM

(71) Applicant: Samsung Electronics Co., Ltd., Suwon-si (KR)

(72) Inventors: Byounghoon JUNG, Suwon-si (KR); Anil AGIWAL, Santa Clara, CA (US); Sangkyu BAEK, Suwon-si (KR); June HWANG, Suwon-si (KR)

(21) Appl. No.: 18/626,013

(22) Filed: Apr. 3, 2024

Related U.S. Application Data
(60) Provisional application No. 63/494,426, filed on Apr. 5, 2023.
(60) Provisional application No. 63/585,151, filed on Sep. 25, 2023.

(51) Int. Cl. H04W 36/36; H04W 36/00; H04W 72/232; H04W 76/28

(52) U.S. Cl. CPC H04W 36/362; H04W 36/00837; H04W 72/232; H04W 76/28

(57) ABSTRACT

This disclosure relates to 5G or 6G communication systems to support higher data rates. This disclosure discloses a handover method and apparatus of a terminal according to the status of a terminal and network in an NES system.

### CROSS REFERENCE TO RELATED APPLICATION

This application is based on and claims the benefit of U.S. Provisional Patent Application Nos. 63/494,426 and 63/585,151, filed on Apr. 5, 2023, and Sep. 5, 2023, in the U.S. Patent and Trademark Office, the disclosures of which are herein incorporated by reference in its entirety.

### BACKGROUND

### 1. Field

The present disclosure relates to the operations of a terminal and base station in a wireless communication system, and more specifically, to a handover method and apparatus according to the status of the terminal and network in a network energy saving (NES) system that supports power saving technology.

### 2. Description of the Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) such as 28 GHz and 39 GHz. In addition, it has been considered to implement sixth generation (6G) mobile communication technologies, which is referred to as Beyond 5G systems, in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting various numerologies (operating a plurality of subcarrier spacings, etc.) for efficiently utilizing mmWave resources and dynamic operation of slot formats, initial access technologies for supporting multi-beam transmission and broadbands, definition and operation of Band-Width Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, Mobile Edge Computing (MEC) for receiving services based on UE positions, and the like.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, drone communication, and the like.

Furthermore, such development of 5G mobile communication systems will serve as a basis for developing not only new waveforms for securing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS) technology, but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Meanwhile, mobility support methods and apparatus using the location information of the terminal have been provided in non-terrestrial network systems, and for terminals that can utilize such methods and apparatus, a need for a mobility support method that uses relative position measurement between the terminal and the network, different from the existing signal strength-based method, has emerged.

### SUMMARY

One object of the disclosure is to provide a method and apparatus for improving handover performance of a terminal using power saving mode operation information of a network in a wireless communication system.

In order to solve the above problem, the disclosure provides a method for processing a control signal in a wireless communication system, comprising receiving a first control signal transmitted from a base station; processing the received first control signal; and transmitting a second control signal generated based on the processing to the base station.

In addition, a method for performing a handover according to a condition by a terminal using power saving mode operation information of any network, according to an embodiment of the disclosure, may comprise an operation of a first base station to configure a handover condition for conditional handover for a terminal according to a power saving mode operation of neighboring base stations including the first base station, an operation of the terminal to identify power saving mode status information of the neighboring base stations including the first base station, an operation of the terminal to determine an occurrence of a specific event based on the information, for example, an operation of the terminal to determine whether to trigger a handover to the neighboring base stations, and an operation of performing the handover to a corresponding neighboring base station in case where it is determined that the specific event has occurred.

According to the disclosure, handover of a terminal can be performed more quickly by effectively utilizing power saving mode operation information of a network in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of an NR system according to an embodiment of the disclosure;

FIG. 2 illustrates a NES mode concept of a base station or cell according to an embodiment of the present disclosure;

FIG. 3 illustrates a serving cell, a candidate cell of CHO, and a CHO procedure of a terminal according to an embodiment of the present disclosure;

FIG. 4 illustrates a signal transmission procedure in which a serving cell collects the NES status of neighboring candidate cells and provides collected information to a terminal according to an embodiment of the present disclosure;

FIG. 5 illustrates a procedure in which a terminal directly collects NES status information transmitted by a serving cell and neighboring candidate cells according to an embodiment of the present disclosure;

FIG. 6 illustrates a procedure in which a terminal directly collects NES status information from a serving cell or neighboring candidate cells upon request according to an embodiment of the present disclosure;

FIG. 7 illustrates a procedure in which a serving cell configures a CHO to a terminal and the terminal performs the CHO according to an embodiment of the present disclosure;

FIG. 8 illustrates a structure of a base station according to an embodiment of the present disclosure; and

FIG. 9 illustrates a structure of a terminal according to an embodiment of the present disclosure.

### DETAILED DESCRIPTION

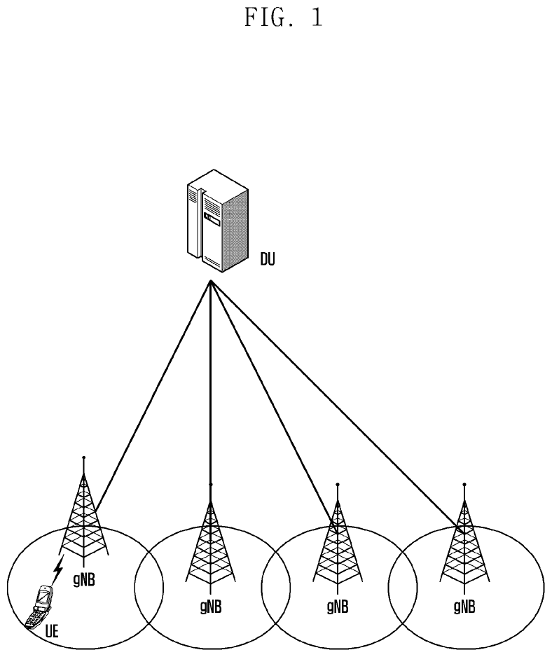

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operating principle of the present disclosure will be described in detail with reference to accompanying drawings. Hereinafter, in describing the disclosure, a detailed description of known functions and constitutions incorporated herein will be omitted when it is determined that the detailed description may unnecessarily obscure the gist of the disclosure. Furthermore, terms to be described hereunder have been defined by taking into consideration functions in the disclosure, and may be different depending on a user, an operator's intention or practice. Accordingly, each term should be defined based on contents over the entire specification.

In the following description, terms identifying access nodes, terms indicating network entities, terms indicating messages, terms indicating interfaces between network entities, terms indicating various types of identification information, etc. are merely selected for convenience of explanation. Therefore, the disclosure is not limited to these terms and other terms having technically equivalent meanings may also be used.

Hereinafter, a base station may be an entity allocating resource to a terminal and may be at least one of gNode B, eNodeB, Node B, base station (BS), radio access unit, base station controller, and node over network. The terminal may include user equipment (UE), mobile station (MS), cellular phone, smartphone, computer, or multimedia system capable of performing communication functions. In the disclosure, a downlink (DL) may refer to a wireless transmission path of signal transmitted from the base station to the terminal, and an uplink (UL) refers to a wireless transmission path of signal transmitted from the terminal to the base station. In addition, although long term evolution (LTE) or LTE-advanced (A) system is described as an example, embodiments of the disclosure may also apply to other communication systems with a similar technical background or channel form. For example, the 5th generation mobile communication technology (5G, new radio, NR) developed after LTE-A may be included in a system to which embodiments of the disclosure can be applied. Hereinafter, 5G may be a concept that includes existing LTE, LTE-A, and other similar services. Furthermore, the disclosure will also be applied to other communication systems through some modifications to an extent that does not significantly deviate from the scope of the disclosure when judged by those of ordinary skill in the art. Here, it will be understood that combinations of blocks in flowcharts or process flow diagrams may be performed by computer program instructions.

Because these computer program instructions may be loaded into a processor of a general purpose computer, a special purpose computer, or another programmable data processing apparatus, the instructions, which are performed by a processor of a computer or another programmable data processing apparatus, generate means for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction means for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function. Here, the term “unit” used in the disclosure means a software component or hardware component such as field programmable gate array (FPGA) or application specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units,” or may be further divided into additional components and “units.” Furthermore, the components and “units” may be embodied to reproduce one or more CPUs in a device or security multimedia card. In addition, in an embodiment, “units” may include one or more processors.

For convenience of explanation below, the disclosure will be described using terms and names defined in the 5GS and NR standards, which are the standards defined by the 3rd generation partnership project (3GPP) organization among the existing communication standards. However, the disclosure is not limited by these terms and names, and may be applied in the same way to wireless communication networks that conform other standards. For example, the disclosure may be applied to the 3GPP 5GS/NR (5th generation mobile communication standards).

FIG. 1 illustrates a structure of an NR system according to an embodiment of the present disclosure.

With reference to FIG. 1, a wireless access network of an NR system includes a next-generation base station (g Node B, hereinafter, gNB, Node B, or base station) and a core network (CN). A user equipment (hereinafter, UE) or terminal accesses an external network through the gNB and CN.

In FIG. 1, the gNB corresponds to an existing node B of a universal mobile telecommunication system (UMTS) or an existing enhanced node B (ENB) of a long term evolution (LTE) system. The gNB may be connected to the UE through a wireless channel, and may perform a more complex role than the existing ENB. In the NR system, since all user traffic including a real-time service such as voice over IP (VOIP) via an Internet protocol is served via a shared channel, a device collecting and scheduling status information such as buffer statuses of UEs, available transmission power status, and channel statuses is required, and the gNB serves as this device. One gNB may normally control multiple cells. For example, in order to implement a transmission rate of 100 Mbps, the NR system may use orthogonal frequency division Multiplexing (OFDM) as a radio access technology in a bandwidth of 20 MHz. In addition, an adaptive modulation and coding (hereinafter, referred to as “AMC”) scheme is applied to determine a modulation scheme and a channel coding rate in accordance with the channel status of a terminal.

The NR CN performs functions such as mobility support, bearer configuration, and quality of service (QOS) configuration. The CN is a device that performs various control functions, as well as a mobility management function for a terminal, and is connected to a plurality of base stations. In addition, the next-generation mobile communication system may interwork with the existing LTE system, and the CN is connected to a mobility management entity (MME) through a network interface. The MME is connected to the eNB, which is an existing base station.

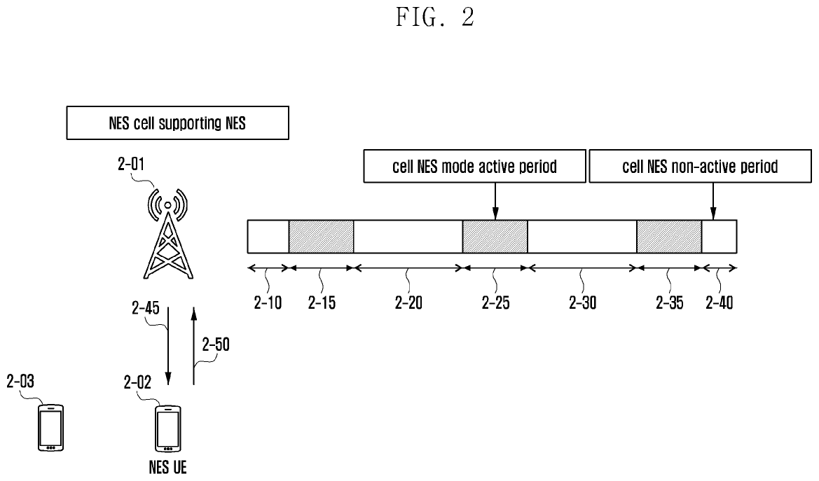

FIG. 2 illustrates a NES mode concept of a base station or cell according to an embodiment of the present disclosure.

The NES cell 2-01, which is a cell that supports a network energy saving (NES) function, may perform operations such as transmitting and/or receiving signals only during a specific period for the purpose of saving power consumption of network equipment. For example, the NES cell may operate by selecting a cell discontinuous transmission (DTX)/discontinuous reception (DRX) mode as an NES mode, and in this cell DTX/DRX mode operation, the NES cell may transmit signals (2-45) and receive signals from an NES terminal 2-02 (2-50) in an active period (2-15, 2-25, 2-35). That is, the NES cell 2-01 may not transmit signals and does not receive signals from the terminal in the cell DTX/DRX non-active period (2-10, 2-20, 2-30, 2-40). The NES cell 2-01 may broadcast an indicator indicating support for the NES function in system information (e.g., master information block (MIB) or system information block type 1 (SIB1)). The NES cell 2-01 may activate the NES mode according to a specific pattern and broadcast this in system information. For example, the NES cell 2-01 may include the periodicity for the NES mode, start slot/offset indicating the starting point, and NES mode activation period (on duration) in the system information and broadcast the same. Accordingly, the NES terminal 2-02 may synchronize with the NES cell 2-01, measure the NES cell 2-01, or camps-on to the NES cell 2-01, or reselect the NES cell 2-01.

For reference, the NES cell 2-01 may bar the connection of a conventional terminal so that the conventional terminal 2-03 does not access it. For example, the NES cell 2-01 may be barred so that the existing terminal 2-03 does not perform cell (re) selection of the cell 2-01 through information stored in the MIB.

Meanwhile, examples of various NES modes that the NES cell may select may include the following technologies.

1. A cell DTX mode: an NES cell operating in a cell DTX mode does not transmit signals to the terminal, causing the circuit related to transmission to operate in a power saving mode for a predetermined period of time, or to turn off the power of a corresponding circuit so that the power consumption of the base station can be reduced.

1-1. A cell DTX mode supporting new radio (NR) wake up signal (WUS): an NES cell operating in a cell DTX mode does not transmit signals to the terminal, causing the circuitry related to transmission to operate in a power saving mode for a predetermined period of time, or to turn off the power of a corresponding circuit so that the power consumption of the base station can be reduced, but in this case, the application of NR WUS may be supported. For example, a specific WUS requesting to terminate the DTX mode of the base station and resume downlink transmission, that is, requesting to terminate the cell DTX mode of the base station, may be received from the terminal through the NR.

1-2. A cell DTX mode supporting other radio access technology (RAT) WUS: an NES cell operating in a cell DTX mode does not transmit signals to the terminal, causing the circuit related to transmission to operate in a power saving mode for a predetermined period of time or to turn off the corresponding circuit so that the power consumption of the base station can be reduced, but in this case, the application of WUS may be supported through other RAT, not the NR. For example, a WUS requesting to terminate the DTX mode of the base station and resume downlink transmission, that is, requesting to terminate the cell DTX mode of the base station, may be received from the terminal through other RATs, such as LTE, Wi-Fi, or wireless local access network (WLAN), Bluetooth, ZigBee, or another RAT other than NR.

2. A cell DRX mode: an NES cell operating in a cell DRX mode does not receive signals, causing the circuit related to reception to operate in a power saving mode for a predetermined period of time or to turn off the power of the corresponding circuit so that the power consumption of the base station can be reduced.

2-1. A cell DRX mode supporting NR WUS: an NES cell operating in a cell DRX mode does not receive signals from the terminal, causing the circuit related to reception to operate in a power saving mode for a predetermined period of time or to turn off the power of the corresponding circuit so that the power consumption of the base station can be reduced, but in this case, by supporting the application of NR WUS, any WUS requesting to terminate the DRX mode of the base station and resume uplink reception, in other words, requesting to terminate the cell DRX mode of the base station may be received from the terminal through NR.

2-2. A cell DRX mode supporting other RAT WUS: an NES cell operating in a cell DRX mode does not receive signals from the terminal, causing the circuit related to reception to operate in a power saving mode for a predetermined period of time or to turn off the power of the corresponding circuit so that the power consumption of the base station can be reduced, but in this case, the reception of NR WUS may be supported. For example, any WUS requesting to terminate the DRX mode of the base station and resume uplink reception, in other words, requesting to terminate the cell DRX mode of the base station may be received from the terminal through other RAT, such as LTE, Wi-Fi, or WLAN, Bluetooth, ZigBee, or another RAT other than NR.

3. A spatial domain NES mode: an NES cell may reduce the power consumption of the base station by adaptively adjusting the number of antenna ports or the number of transmission circuit chains of the base station. In general, when the spatial domain NES mode is activated, the base station is in a state of reducing the number of antenna ports or the number of transmission circuit chains, thereby reducing power consumption. However, at the same time, performance may also deteriorate to a certain extent due to the reduced number of circuit chains or antenna ports.

4. A power domain NES mode: an NES cell may reduce the power consumption of the base station by adaptively adjusting the transmission/reception power of the base station and various power amounts or power offset values applicable to other transmission/reception circuit chains. In general, when the power domain NES mode is activated, the base station is in a state of reducing transmission and reception power, so power consumption can be reduced. However, at the same time, performance may also deteriorate to a certain extent depending on the reduced signal strength.

5. A frequency domain NES mode: an NES cell may reduce the power consumption of the base station by adaptively adjusting the operating frequency bandwidth value of the base station. For example, the base station may reduce power consumption by leaving only a bandwidth part with the minimum bandwidth required for communication, not allocating resources and user equipment to other bandwidths, and operating only the minimum antenna configurations and circuits necessary to operate only the corresponding bandwidth. In general, when Freq domain NES mode is activated, the base station is a state of using less bandwidth, thereby reducing power consumption. However, at the same time, performance may also deteriorate to some extent depending on the reduced bandwidth.

6. A synchronization signal block (SSB)-less NES mode: an NES cell may reduce power consumption of the base station by adaptively adjusting the transmission of periodically transmitted synchronization and broadcast signals, for example, SSB. For example, the base station may not only save SSB transmission power by not transmitting all or part of the SSB in a specific cell and at a specific time, but also save power by operating in a sleep mode for a longer period of time than the SSB transmission period. In general, when the SSB-less NES mode is activated, the base station is in a state of transmitting a relatively small number of SSBs, thereby reducing power consumption. However, at the same time, depending on the reduced number of SSBs, performance may deteriorate to a certain extent due to delays in channel measurement or cell reselection and reconnection of terminals.

7. A system information block (SIB)-less NES mode: an NES cell may reduce power consumption of the base station by adaptively adjusting the transmission of system information signals, such as SIB, transmitted periodically or at the request of the terminal. For example, the base station may save transmission power by not transmitting all or part of the SIB in a specific cell at a specific time. In general, when SIB-less NES mode is activated, the base station is in a state of transmitting a relatively small number of SIBs, thereby reducing power consumption. However, at the same time, in case where the system information transmitted to the terminals needs to be changed according to the reduced number of SIBs, a certain amount of delay may occur.

8. A NR WUS-based NES mode: a NES cell may cause a corresponding cell to start or terminate an operation that currently supports reception of NR WUS. In this case, by providing this information to the terminals belonging to the cell, the terminal may determine whether to use WUS. Here, the WUS may be a signal transmitted from the terminal to the base station, requesting to terminate the NES mode currently being used by a specific NES cell, for example, cell DTX/DRX mode, and resume signal transmission/reception. The terminal may identify the NR channel capable of WUS transmission that has been configured through in advance through a radio resource control (RRC) message or other messages, such as medium access control (MAC) control element (CE) or OAM messages, etc. with the base station, or is recognized by implementation according to the standard. The WUS may be transmitted to a neighboring base station or a base station that has configured the corresponding channel through the identified channel.

9. A other RAT WUS-based NES mode: an NES cell may start or terminate an operation that supports reception of WUS through a specific RAT. In this case, by providing this information to the terminals belonging to the cell, it is possible to help the terminal determine whether to use WUS. Here, the WUS may be a signal transmitted from the terminal to the base station, requesting to terminate the NES mode currently being used by the NES cell, for example, cell DTX/DRX mode, and resume signal transmission/reception. The terminal may identify the RAT and channel capable of WUS transmission that has been configured through in advance through an RRC message or other messages, such as MAC-CE or OAM messages, etc. with the base station, or is recognized by implementation according to the standard. The WUS may be transmitted to a neighboring base station or a base station that has configured the corresponding channel through the identified channel.

10. A cell DTX/DRX mode: an NES cell operating in a cell DTX/DRX mode may not transmit or receive signals to the terminal, causing the circuit related to transmission and reception to operate in a power saving mode for a predetermined period of time, or turn off the power of the corresponding circuit so that the power consumption of the base station can be reduced.

10-1. A cell DTX/DRX mode supporting NR WUS: an NES cell operating in a cell DTX/DRX mode may not transmit or receive signals to the terminal, causing the circuit related to transmission and reception to operate in a power saving mode for a predetermined period of time, or turn off the power of the corresponding circuit so that the power consumption of the base station can be reduced. In this case, the application of NR WUS may be supported. For example, a WUS requesting to terminate the cell DTX/DRX mode of the base station and resume uplink/downlink transmission and reception, that is, requesting to terminate the cell DTX/DRX mode of the base station, may be received from the terminal through NR.

10-2. A cell DTX/DRX mode supporting other RAT WUS: an NES cell operating in a cell DTX/DRX mode may not transmit or receive signals to the terminal, causing the circuit related to transmission and reception to operate in a power saving mode for a predetermined period of time, or turn off the power of the corresponding circuit so that the power consumption of the base station can be reduced. In this case, the application of WUS may be supported through other RAT, not the NR. For example, a WUS requesting to terminate the DTX/DRX mode of the base station and resume uplink/downlink transmission and reception, that is, requesting to terminate the cell DTX/DRX mode of the base station, may be received from the terminal through other RAT, for example, LTE, Wi-Fi or WLAN, Bluetooth, ZigBee, or any other RAT.

The base station may provide the terminal with information about the NES mode supported by the base station among the NES modes.

For example, the base station may use a list of identities (IDs) or a bitmap to indicate the NES mode. In the case of a bitmap, each bit may indicate one NES mode, and if the value of the bit is 1, each bit may indicate that the base station supports the corresponding NES mode. Alternatively, if the value of the corresponding bit is 0, the bit may be configured to indicate that the base station supports the corresponding NES mode. In the case of a list of IDs, the base station may provide the terminal with a list of IDs indicating the NES modes supported by the base station.

In an embodiment, the signal transmitted by the base station may include a bitmap or ID indicating the NES modes supported by the base station.

In an embodiment, the bitmap or ID may indicate the NES modes supported by the base station and currently operating, for example, operating in a power saving mode.

In an embodiment, the base station, along with the NES modes, may provide to the terminal with information related to the schedule in which each NES mode operates, such as a periodicity and information about on-duration that allows to know the time when the base station operates in the NES mode within the period and when the base station does not operate in the NES mode within the period.

In an embodiment, the base station, along with the NES modes, may provide to the terminal with information related to the schedule in which each NES mode operates, such as the start point of a period, a periodicity, and information about on-duration that allows to know the time when the base station operates in the NES mode within the period and when the base station does not operate in the NES mode within the period.

The base station may transmit the information through a broadcast signal, for example, SIB, or may transmit the information to the terminal through a groupcast, multicast, or unicast signal, such as an RRC, MAC, or PHY signal.

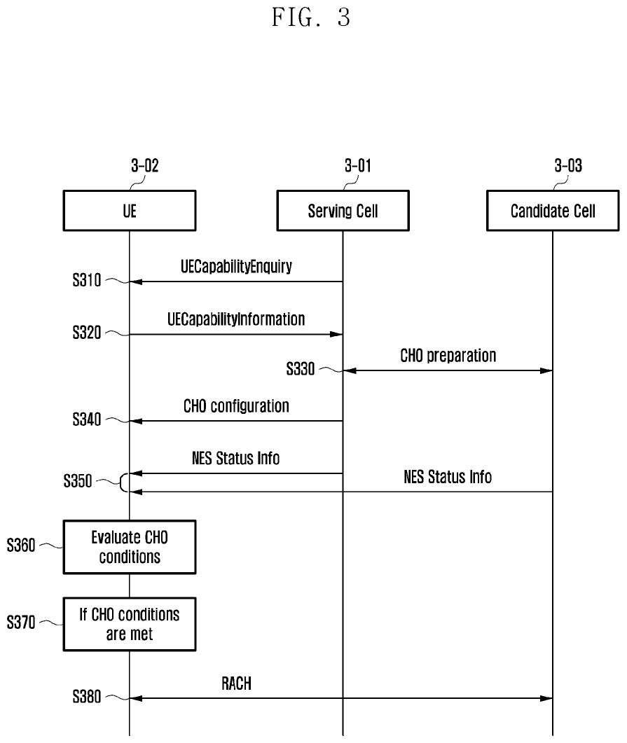

FIG. 3 illustrates a serving cell, a candidate cell of CHO, and a CHO procedure of a terminal according to an embodiment of the present disclosure.

With reference to FIG. 3, a serving cell 3-01 requests a terminal 3-02 to transmit UE Capability Information (S310), and the terminal 3-02 may provide capability information to the serving cell 3-01 accordingly (S320). In this case, UE capability information transmitted from the terminal 3-02 to the base station 3-01 may be transmitted by including information indicating which NES mode among the NES modes the terminal may perform conditional handover (CHO) when the base station operates, for example, information as shown in [Table 1] below.

TABLE 1
UE capability information about the NES modes of the
base station in which the terminal supports CHO

condHandoverWithNES-CellDTX/DRX
Indicates whether the UE supports conditional handover with NES Cell DTX/DRX configuration.
The UE indicating support of this feature shall also indicate the support of condHandover-r16.
condHandoverWithNES-CellDTX
Indicates whether the UE supports conditional handover with NES Cell DTX configuration. The
UE indicating support of this feature shall also indicate the support of condHandover-r16.
condHandoverWithNES-CellDRX
Indicates whether the UE supports conditional handover with NES Cell DRX configuration. The
UE indicating support of this feature shall also indicate the support of condHandover-r16.
condHandoverWithNES-Spatial
Indicates whether the UE supports conditional handover with NES Spatial domain configuration.
The UE indicating support of this feature shall also indicate the support of condHandover-r16.
condHandoverWithNES-Power
Indicates whether the UE supports conditional handover with NES Power domain configuration.
The UE indicating support of this feature shall also indicate the support of condHandover-r16.
condHandoverWithNES-BW (or BWP)
Indicates whether the UE supports conditional handover with NES BW (or BWP) configuration.
The UE indicating support of this feature shall also indicate the support of condHandover-r16.
condHandoverWith NES-WUS
Indicates whether the UE supports conditional handover with NES Wake Up Signal (WUS)
configuration. The UE indicating support of this feature shall also indicate the support of
condHandover-r16.

The serving cell 3-01 identifies a CHO that may be configured for the terminal 3-02 based on the UE capability information, and then, according to the UE capability and the NES modes that the serving cell and neighboring cells may support, the serving cell 3-01 may determine CHO conditions to be configured for the corresponding terminal 3-02 and a neighboring candidate cell to perform the CHO based on the conditions. Then, the serving cell 3-01 may exchange information for CHO preparation with the neighboring candidate cell 3-03 (S330) and then configure CHO for the corresponding terminal 3-02 based on this. In this case, the serving cell 3-01 may transmit the CHO configuration including this information to the terminal 3-03 through an RRC reconfiguration message (S340).

The serving cell base station 3-01 may configure a new CHO trigger condition as follows for the terminal 3-02 according to the NES mode supported by the terminal 3-02, serving cell 3-01, and other neighboring cells 3-03.

For example, the base station 3-01 may configure a condition for the terminal 3-02 to trigger CHO when the serving cell starts operating in a specific NES mode.

In this case, the terminal 3-02 may identify which NES mode the base station 3-01 has started operating (S360) through the NES mode status information of the serving cell or NES mode operation schedule information of the serving cell included in the signal transmitted by the base station 3-01 (S350).

As an example, the NES mode status information of the serving cell or the NES operation schedule information of the serving cell may be as follows:
CondEvent N1: Conditional reconfiguration serving goes into NES mode 1: DTX;
CondEvent N2: Conditional reconfiguration serving goes into NES mode 2: DRX;
CondEvent N3: Conditional reconfiguration serving goes into NES mode 3: Spatial;
CondEvent N4: Conditional reconfiguration serving goes into NES mode 4: Power;
CondEvent N5: Conditional reconfiguration serving goes into NES mode 5: WUS; and
CondEvent N6: Conditional reconfiguration serving goes into NES mode 6: DTX/DRX.

Here, “goes into” may be replaced with “comes out of,” “operating,” “not operating,” “out of,” or “in.”

In addition, for example, the base station 3-01 may configure conditions for the terminal to trigger CHO to the corresponding cell when a certain candidate cell terminates an operation in a specific NES mode, that is, when the corresponding candidate cell 3-03 stops a power saving mode operation.

In this case, the terminal 3-02 may identify which NES mode operation the candidate cell 3-03 has terminated through the NES mode status information or NES mode operation schedule information of the candidate cell included in the signal transmitted by the serving cell 3-01 or candidate cell 3-03 base station (S350).

As an example, the NES mode status information or NES mode operation schedule information of a candidate cell may be as follows:
CondEvent M1: Conditional reconfiguration candidate comes out of NES mode 1: DTX;
CondEvent M2: Conditional reconfiguration candidate comes out of NES mode 2: DRX;
CondEvent M3: Conditional reconfiguration candidate comes out of NES mode 3: Spatial;
CondEvent M4: Conditional reconfiguration candidate comes out of NES mode 4: Power;
CondEvent M5: Conditional reconfiguration candidate comes out of NES mode 5: WUS; and
CondEvent M6: Conditional reconfiguration candidate comes out of NES mode 6: DTX/DRX.

Here, “comes out of” may be replaced with “goes into,” “operating,” “not operating,” “out of,” or “in.”

The determination of whether the above conditions are satisfied is not performed through measurement of the terminal, such as the received signal strength or distance conventionally, but is performed based on the NES mode of the cell provided by the base station and the operation information of the corresponding mode. Methods for providing such information will be described later.

It is apparent that the above conditions may be configured by the base station to perform CHO in case where one or more than one condition is satisfied at the same time. Also, it is apparent that various other conditions supported by existing standards, such as signal strength conditions determined by comparing the received signal strength with the threshold configured by the base station, or distance conditions determined by comparing a distance between the reference location measured by the terminal and a terminal location and the threshold value configured by the base station, may be combined and configured.

Although described above as conditions for triggering CHO, the corresponding conditions may be triggering conditions for transmitting a measurement report that is the same or similar to existing ones, or conditions for performing other handovers such as random access channel (rach)-less handover.

The conditions for triggering the CHO may be configured through an RRC message transmitted from the base station to the terminal, for example, an RRC reconfiguration message. In this case, the RRC information element (IE) may be an IE included in CondReconfigToAddModList configured for CHO as shown in [Table 2].

```
TABLE 2
CondReconfigToAddModList
The IE CondReconfigToAddModList concerns a list of conditional reconfigurations to add or
modify, with for each entry the condReconfigId and the associated
condExecutionCond/condExecutionCondSCG and condRRCReconfig.
                    CondReconfigToAddModList information element
-- ASN1START
-- TAG-CONDRECONFIGTOADDMODLIST-START
CondReconfigToAddModList-r16 ::= SEQUENCE (SIZE (1.. maxNrofCondCells-r16)) OF
CondReconfigToAddMod-r16
CondReconfigToAddMod-r16 ::= SEQUENCE {
  condReconfigId-r16 CondReconfigId-r16,
  condExecutionCond-r16 SEQUENCE (SIZE (1..2)) OF MeasId
    OPTIONAL, -- Need M
  condRRCReconfig-r16 OCTET STRING (CONTAINING RRCReconfiguration)
    OPTIONAL, -- Cond condReconfigAdd
    ...,
    [[
  condExecutionCondSCG-r17 OCTET STRING (CONTAINING
    CondReconfigExecCondSCG-r17) OPTIONAL -- Need M
    ]]
    [[
    condExecutionCondNES-r18 SEQUENCE (SIZE (1..2)) OF MeasId OPTIONAL --
Need M
    ]]
}
CondReconfigExecCondSCG-r17 ::= SEQUENCE (SIZE (1..2)) OF MeasId
-- TAG-CONDRECONFIGTOADDMODLIST-STOP
-- ASN1STOP
Where condExecutionCondNES-r18 indicates CHO triggering conditions considering A)
serving cell goes into an NES mode and/or B) target cell comes out of an NES mode
```

Here, condExecutionCondNES-r18 IE, for example, can be configured to a sequence of IDs in Measurement Configuration that includes conditions for performing CHO according to the NES mode operation status of the serving cell and candidate cell.

As shown in FIG. 3, the terminal 3-02, which has received the configuration of the above-described CHO configuration, obtains the NES status of the serving cell 3-01 and neighboring candidate cell 3-03 based on the corresponding configuration, and then, evaluate and determine the status of the corresponding cells, other channel conditions, etc. based on the configured conditions. In case of satisfying the condition (S370), the terminal 3-02 may trigger CHO to the neighboring candidate cell 3-03 for which the condition is satisfied and perform a handover to the corresponding candidate cell through a cell access procedure using RACH (S380).

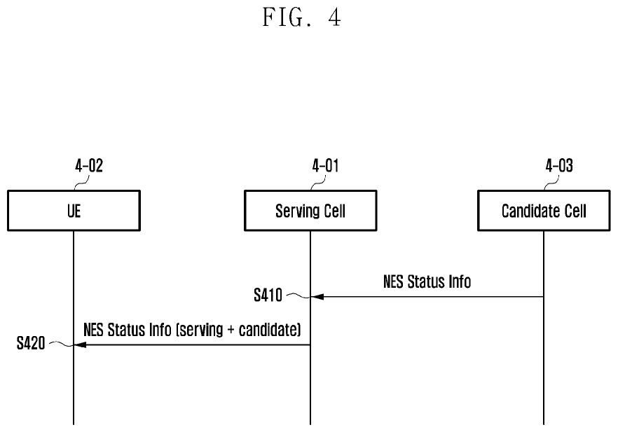

Hereinafter, with reference to FIGS. 4 to 6, various methods for a terminal to receive the NES status of a serving cell and neighboring candidate cell will be described.

FIG. 4 illustrates a signal transmission procedure in which a serving cell collects the NES status of neighboring candidate cells and provides collected information to a terminal according to an embodiment of the present disclosure.

In the embodiment, the signal through which a serving cell 4-01 transmits the corresponding information to a terminal 4-02 may be one of signals transmitted through Unicast, Groupcast, or Multicast, for example, one of RRC, MAC, or PHY signals.

The serving cell 4-01 may transmit the NES status information of the cells to the terminal 4-02 along with the CHO configuration information described in detail with respect to FIG. 3 by including the same in one RRC message, for example, an RRC reconfiguration message.

In addition, the serving cell 4-01 may provide the current NES status information of the neighboring cells 4-03 which is previously received (S410) to a terminal newly connected to the serving cell or a terminal requesting information about the serving cell, etc. 4-02 (S420). In this case, the serving cell 4-01 may obtain power saving benefits, etc. by not additionally collecting current NES status information from the neighboring cells 4-03.

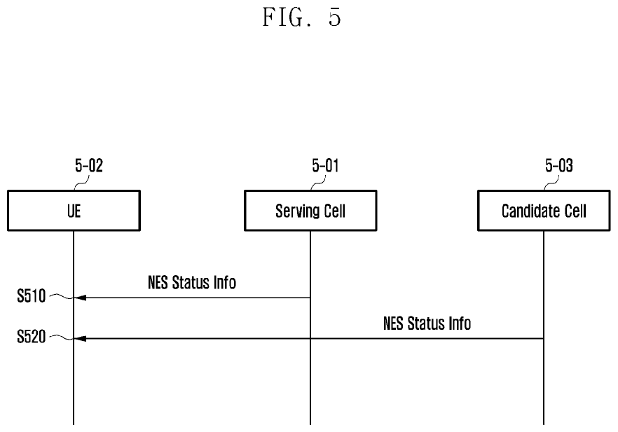

FIG. 5 illustrates a procedure in which a terminal directly collects NES status information transmitted by a serving cell and neighboring candidate cells according to an embodiment of the present disclosure.

In the embodiment, the signal through which the respective cells 5-01, 5-03 transmit the corresponding information to the terminal 5-02 is a signal transmitted through Unicast, Groupcast, or Multicast, for example, one of RRC, MAC, PHY signals. For example, the respective cells 5-01, 5-03 may transmit the NES status information of the corresponding cell by including the same in the RRC signal or SIB signal, such as an RRC reconfiguration signal broadcast to or transmitted to the terminal 5-02 (S510, S520).

A terminal 5-02 that supports NES, or a terminal 5-02 that supports NES-based CHO may necessarily receive the SIB including the NES status information of the serving cell 5-01 or neighboring cell 5-03.

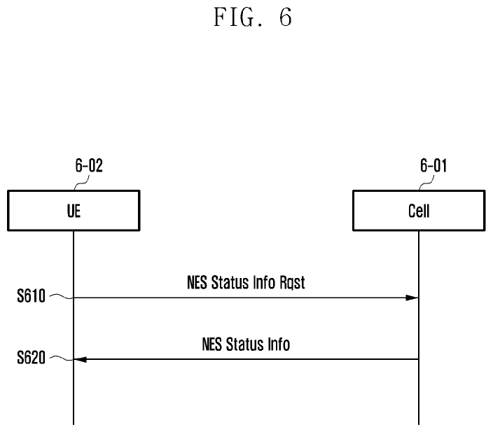

FIG. 6 illustrates a procedure in which a terminal directly collects NES status information from a serving cell or neighboring candidate cells upon request according to an embodiment of the present disclosure.

As an example, in case where the cell shown in FIG. 6 is a serving cell 6-01, a terminal 6-02 may transmit an NES request signal to the corresponding serving cell 6-01 through an RRC, MAC, or PHY signal (S610), and the requested information may be received from the corresponding serving cell 6-01 (S620).

In addition, as an example, in case where the cell shown in FIG. 6 is the neighboring candidate cell 6-01, the terminal may transmit an NES request signal using a 4 step or 2 step random access procedure (S610), and the requested information may be received from the corresponding neighboring candidate cell 6-01 (S620).

It is apparent that the signals may be transmitted and received through a general signal transmission and reception procedure, or a 4 step or 2 step random access procedure, in addition to the RRC, MAC, or PHY signal,

As an example, the NES status information of a cell may include the cell ID of the corresponding cell, a mode indicator of the NES mode, and information about the NES operation state (on/off) of each NES mode.

In addition, as an example, the NES state information may not include a cell ID, even if it is a serving cell or a candidate cell that is not a serving cell, in case where the cell ID is included in the signal including the corresponding status information.

In addition, as an example, the NES status information may not include an NES mode indicator in case where the number of NES modes is limited to one.

The cell may select an information structure constructed with one of the examples below in order to provide the terminal with the NES mode supported by the corresponding cell and the operating status of each NES mode.

In an embodiment, the information structure may include, as shown in [Table 3] below, a bitmap for the NES mode in which each bit indicates a different NES mode (a bit value of 1 in case of the NES mode supported by a corresponding cell, a bit value of 0 in case of the NES mode not supported by the corresponding cell), and a bitmap for status of the NES mode in which each bit indicates whether a different NES mode is currently operating in a power saving mode (in case of operating, a bit value of 1) or not (in case of not operating, a bit value of 0).

TABLE 3
Bitmap structure type 1

| | |
|---|---|
| Bitmap of supported | Bitmap of supported NES |
| NES modes | mode's status (each bit = |
| (each bit = each Mode) | each Mode's NES In (On)/Out |
| | (Off) status) |

In an embodiment, the information structure may include, as shown in [Table 4] below, a bitmap for the NES mode in which each bit indicates a different NES mode currently operating (a bit value of 1 in case of the NES mode supported by a corresponding cell, a bit value of 0 in case of the NES mode not supported by the corresponding cell).

TABLE 4
Bitmap structure type 2

Bitmap of NES mode's status
(each bit = each Mode's NES
In (On)/Out (Off) status)

In an embodiment, the information structure may include, as shown in [Table 5], an ID indicating each NES mode and status info indicating whether the corresponding NES mode is currently on or off.

TABLE 5
Bitmap structure type 3

| | | | | |
|---|---|---|---|---|
| NES | NES | NES | NES | . . . |
| Mode | Mode | Mode | Mode | |
| 1's | 1's | 2's | 2's | |
| ID | status | ID | status | |

In an embodiment, the information structure may include, as shown in [Table 6] below, a bitmap for the NES mode in which each bit indicates a different NES mode (a bit value of 1 in case of the NES mode supported by a corresponding cell, a bit value of 0 in case of the NES mode not supported by the corresponding cell), and schedule-related information, with each info operating in different NES modes, for example, a periodicity and information about on duration that allows to know the time when the base station operates in the NES mode within the period and when the base station does not operate in the NES mode within the period.

TABLE 6
Bitmap structure type 4

| | | | |
|---|---|---|---|
| Bitmap of supported | The first | The second | . . . |
| NES modes | NES mode's | NES mode's | |
| (each bit = | Schedule (e.g., | Schedule (e.g., | |
| each Mode) | periodicity + | periodicity + | |
| | on-duration) | on-duration) | |

In an embodiment, the information structure may include, as shown in [Table 7], an ID indicating each NES mode and status info indicating whether the corresponding NES mode is currently on or off.

TABLE 7
Bitmap structure type 5

| | | | | |
|---|---|---|---|---|
| NES | The first | NES | The second | . . . |
| Mode | NES mode's | Mode | NES mode's | |
| 1's | Schedule (e.g., | 2's | Schedule (e.g., | |
| ID | periodicity + | ID | periodicity + | |
| | on-duration) | | on-duration) | |

In an embodiment, the information structure may include, as shown in [Table 8] below, a cell ID indicated by corresponding information, a bitmap for the NES mode in which each bit indicates a different NES mode (a bit value of 1 in case of the NES mode supported by a corresponding cell, a bit value of 0 in case of the NES mode not supported by the corresponding cell), and a bitmap for status of the NES mode in which each bit indicates whether a different NES mode is currently operating in a power saving mode (in case of operating, a bit value of 1) or not (in case of not operating, a bit value of 0).

TABLE 8
Bitmap structure type 6

| | | |
|---|---|---|
| Cell | Bitmap of supported | Bitmap of supported |
| ID | NES modes | NES mode's status |
| | (each bit = each Mode) | (each bit = each Mode's NES |
| | | In (On)/Out (Off) status) |

In an embodiment, the information structure may include, as shown in [Table 9] below, a serving cell ID, and a bitmap for the NES mode in which each bit indicates a different NES mode currently operating (a bit value of 1 in case of the NES mode supported by a corresponding cell, a bit value of 0 in case of the NES mode not supported by the corresponding cell).

TABLE 9
Bitmap structure type 7

| | |
|---|---|
| Cell | Bitmap of NES mode's status |
| ID | (each bit = each Mode's NES |
| | In (On)/Out(Off) status) |

In an embodiment, the information structure may include, as shown in [Table 10], a serving cell ID, an ID indicating each NES mode, and status info indicating whether the corresponding NES mode is currently on or off.

TABLE 10
Bitmap structure type 8

| | | | | | |
|---|---|---|---|---|---|
| Cell | NES | NES | NES | NES | . . . |
| ID | Mode 1's | Mode 1's | Mode 2's | Mode 2's | |
| | ID | status | ID | status | |

In an embodiment, the information structure may include, as shown in [Table 11] below, a serving cell ID, a bitmap for the NES mode in which each bit indicates a different NES mode (a bit value of 1 in case of the NES mode supported by a corresponding cell, a bit value of 0 in case of the NES mode not supported by the corresponding cell), and schedule-related information, with each info operating in different NES modes, for example, a periodicity and information about on duration that allows to know the time when the base station operates in the NES mode within the period and when the base station does not operate in the NES mode within the period.

TABLE 11
Bitmap structure type 9

| | | | | |
|---|---|---|---|---|
| Cell | Bitmap of supported | The first NES mode's | The second | . . . |
| ID | NES modes | Schedule (e.g., | NES mode's | |
| | (each bit = | periodicity + | Schedule (e.g., | |
| | each Mode) | on-duration) | periodicity + | |
| | | | on-duration) | |

In an embodiment, the information structure may include, as shown in [Table 12], a serving cell ID, an ID indicating each NES mode, and status info indicating whether the corresponding NES mode is currently on or off.

TABLE 12
Bitmap structure type 9

| | | | | | |
|---|---|---|---|---|---|
| Cell | NES | The first | NES | The second | . . . |
| ID | Mode | NES mode's | Mode | NES mode's | |
| | 1's | Schedule (e.g., | 2's | Schedule (e.g., | |
| | ID | periodicity + | ID | periodicity + | |
| | | on-duration) | | on-duration) | |

In an embodiment, the bitmap or ID included in the signal transmitted by the base station may indicate the NES modes supported by the corresponding base station or associated cell.

In an embodiment, the bitmap or ID may indicate the NES modes supported by the base station and currently operating, for example, the NES modes operating in a power saving mode.

In an embodiment, the base station may include and provide the NES modes and schedule-related information on which respective NES modes operate, such as a periodicity and information about on duration that allows to know the time when the base station operates in the NES mode within the period and when the base station does not operate in the NES mode within the period.

In an embodiment, the base station may include and provide the NES modes and schedule-related information on which respective NES modes operate, such as a start point of a period, a periodicity, and information about on duration that allows to know the time when the base station operates in the NES mode within the period and when the base station does not operate in the NES mode within the period.

In an embodiment, the above-described information may not be configured in the form illustrated in the tables above, but may be configured in the form of a combination of information elements referring to each component.

In an embodiment, one or more pieces of the above-described information may be configured in duplicate. For example, it is apparent that for one cell, one or more NES mode list information supported by the corresponding cell, current operation status information for a corresponding NES mode, and operation schedule information for a corresponding NES mode may be configured in duplicate.

In an embodiment, the NES mode information supported by one or more base stations transmitted from the base station to the terminal, operation status information for each NES mode of each base station, or operation schedule information for each NES mode of each base station may be transmitted through a broadcast signal, a groupcast signal, multicast signal, or unicast signal. In addition, the above information may be provided to the terminal by being included in a system information block, an RRC signal, for example, an RRC reconfiguration signal or a CHO configuration signal, or the information may be included in a MAC signal or PHY signal.

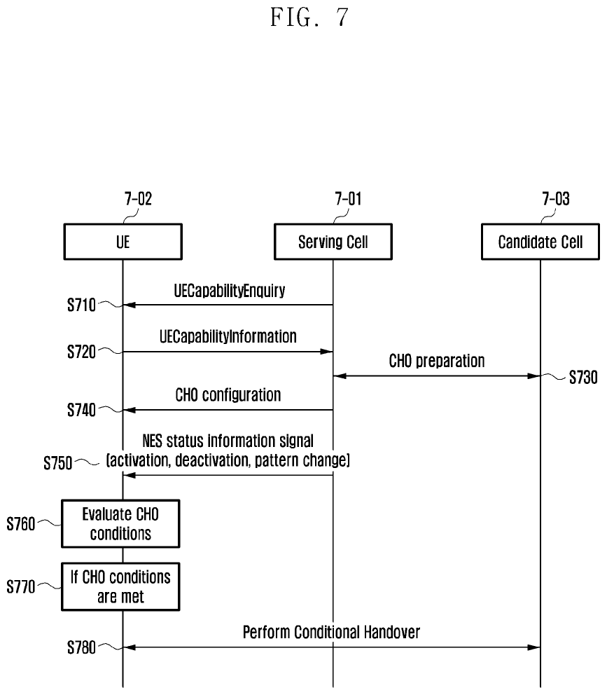

FIG. 7 illustrates a procedure in which a serving cell configures a CHO to a terminal and the terminal performs the CHO according to an embodiment of the present disclosure.

With reference to FIG. 7, a serving cell 7-01 requests a terminal 7-02 to transmit UE capability information of the terminal 7-02 (S710), and the terminal 7-02 may provide the capability information to the serving cell 7-01 accordingly (S720). In this case, the UE capability information transmitted from the terminal 7-02 to the base station 7-01 may include information indicating that the terminal 7-02 supports CHO when the base station 7-1 operates in the specific NES mode.

Alternatively, in an embodiment, the terminal 7-02 may include the information indicating that the terminal 7-02 supports CHO to the base station 7-01 in the UE capability information and transmit the same. Thereafter, the serving cell 7-01 may transmit and receive signals including all or some of the following information to and from a candidate cell 7-03 (S730) in order to perform preliminary preparation for CHO of any candidate cell 7-03 and the corresponding terminal 7-02:
Request for CHO to a candidate cell;
CHO response from a candidate cell;
Resources for performing CHO with a candidate cell, for example, physical random access channel (PRACH) resources of a candidate cell for the terminal to perform a random access, for example, information including time, frequency, preamble sequence, etc.;
All or some of the RRC, MAC, and PHY configuration information of a candidate cell;
NES mode information supported by a candidate cell;
Operation pattern information for each NES mode supported by a candidate cell (on, off duration, period, offset, etc.); and/or
Current operation status information for each NES mode of a candidate cell (active/inactive, etc.).

The serving cell 7-01 that has completed CHO preparation with the candidate cell 7-03 may transmit CHO configuration including all or some of the following information to the terminal 7-02 (S740). The terminal 7-02 may identify the conditions for triggering CHO through the corresponding CHO configuration:
The serving cell base station 7-01 may instruct the terminal 7-02 to start CHO upon receiving the following specific signal. To this end, the serving cell 7-01 may include an indicator that performing a trigger upon receiving a specific signal;
Alternatively, the serving cell base station 7-01 may instruct the terminal 7-02 to start evaluation for CHO upon receiving the following specific signal. To this end, the serving cell 7-01 may include an indicator that performs a trigger upon receiving a specific signal;
Alternatively, the serving cell base station 7-01 may instruct the terminal 7-02 to start measurement for CHO upon receiving the following specific signal. To this end, the serving cell 7-01 may include an indicator that performs a trigger upon receiving a specific signal;
Alternatively, the serving cell base station 7-01 may instruct the terminal 7-02 to start CHO in accordance with the NES operation timing of the base station upon receiving a specific signal related to any of the following NES modes. To this end, the serving cell 7-01 may include an indicator that performs a trigger upon receiving a specific signal. For example, the serving cell base station 7-01 may configure to identify the DTX operation pattern of the serving cell when the terminal 7-02 receives the DTX activation signal of the serving cell from the base station and perform CHO when the serving cell transitions to a DTX mode according to the pattern;
The specific signals described above may include the following signals:
Any NES status and/or pattern information signal from a serving cell,
NES status and/or pattern information signal of a neighboring cell, ▪NES activation/deactivation indication signal of a serving cell, ▪NES activation/deactivation indication signal of a neighboring cell,
NES pattern change signal of a serving cell,
NES pattern change signal of a neighboring cell,
The signal may be an RRC message, MAC-CE message, or PHY DCI message, and
The signal may include some or all of the information such as the ID of each cell (PCI), each NES mode ID (NES indicator), and each pattern ID (pattern ID);
The serving cell base station 7-01 may instruct the terminal 7-02 to start CHO if a CHO trigger condition, which is derived by comparing the cell representative value measurement information, time information, or location information of the serving cell and neighboring cell measured and determined by the terminal, with a threshold value configured by a certain base station, is satisfied:
The serving cell base station 7-01 may configure various radio resource management (RRM) measurement events provided by 3GPP standard documents, such as RRC standard documents (TS 36.331, 38.331) or other standard documents, for example, A series as shown below or all or some of events of B, D, and T series and use them as CHO conditions.

As the RRM measurement event, the following events may be exemplarily applied:
Event A2 (Serving becomes worse than threshold).

The terminal 7-02 may compare the measured value of the serving cell with the threshold value configured by the base station as any signal (RRC signal, MAC signal, or PHY signal), and trigger CHO in case where the measured value of the serving cell 7-01 is less than the corresponding threshold value.

The operations related to this are as shown in [Table 13] below.

TABLE 13
The UE shall:

| 1> | 1> | consider the entering condition for this event to be satisfied when condition |
|---|---|---|
| | A2-1, as specified below, is fulfilled; | |
| 1> | 1> | consider the leaving condition for this event to be satisfied when condition |
| | A2-2, as specified below, is fulfilled; | |
| 1> | 1> | for this measurement, consider the serving cell indicated by the |

measObjectNR associated to this event.

```
Inequality A2-1 (Entering condition)
Ms + Hys < Thresh
Inequality A2-2 (Leaving condition)
Ms − Hys > Thresh
The variables in the formula are defined as follows:
  Ms is the measurement result of the serving cell, not taking into account any offsets.
  Hys is the hysteresis parameter for this event (i.e., hysteresis as defined within
```

reportConfigNR for this event).

Thresh is the threshold parameter for this event (i.e., a2-Threshold as defined within

reportConfigNR for this event).

```
  Ms is expressed in dBm in case of RSRP, or in dB in case of RSRQ and RS-SINR.
  Hys is expressed in dB.
  Thresh is expressed in the same unit as Ms.
```

Event A3 (Neighbour becomes offset better than SpCell).

The terminal 7-02 may attempt measurement within the measurement frequency bands configured by the base station or within the neighboring cell list for measurement configured by the base station, and trigger CHO to find a neighboring cell with better performance than the corresponding cell in case where the measurement value of a specific neighboring cell is greater than the serving cell by a predetermined offset value.

The operations related to this are as shown in [Table 14] below.

TABLE 14
The UE shall:

| | |
|---|---|
| 1> | consider the entering condition for this event to be satisfied when condition A3-1, as |
| | specified below, is fulfilled; |
| 1> | consider the leaving condition for this event to be satisfied when condition A3-2, as |
| | specified below, is fulfilled; |
| 1> | use the SpCell for Mp, Ofp and Ocp. |
| | NOTE 1: The cell(s) that triggers the event has reference signals indicated in the |
| | measObjectNR associated to this event which may be different from the NR SpCell |
| | measObjectNR. |

```
Inequality A3-1 (Entering condition)
Mn + Ofn + Ocn − Hys > Mp + Ofp + Ocp + Off
Inequality A3-2 (Leaving condition)
Mn + Ofn + Ocn + Hys < Mp + Ofp + Ocp + Off
The variables in the formula are defined as follows:
  Mn is the measurement result of the neighbouring cell, not taking into account any offsets.
  Ofn is the measurement object specific offset of the reference signal of the neighbour cell
```

(i.e., offsetMO as defined within measObjectNR corresponding to the neighbour cell).

Ocn is the cell specific offset of the neighbour cell (i.e., cellIndividualOffset as defined

within measObjectNR corresponding to the frequency of the neighbour cell), and set to
zero if not configured for the neighbour cell.

```
  Mp is the measurement result of the SpCell, not taking into account any offsets.
  Ofp is the measurement object specific offset of the SpCell (i.e., offsetMO as defined within
```

measObjectNR corresponding to the SpCell).

Ocp is the cell specific offset of the SpCell (i.e., cellIndividualOffset as defined within

measObjectNR corresponding to the SpCell), and is set to zero if not configured for the
SpCell.

Hys is the hysteresis parameter for this event (i.e., hysteresis as defined within

reportConfigNR for this event).

Off is the offset parameter for this event (i.e., a3-Offset as defined within reportConfigNR

for this event).

```
  Mn, Mp are expressed in dBm in case of RSRP, or in dB in case of RSRQ and RS-SINR.
  Ofn, Ocn, Ofp, Ocp, Hys, Off are expressed in dB.
```

Event A4 (Neighbour becomes better than threshold).

The terminal 7-02 may attempt measurement within the measurement frequency bands configured by the base station or within the neighboring cell list for measurement configured by the base station, and trigger CHO to a neighboring cell with better performance than the corresponding cell in case where the measurement value of a neighboring cell among the searched cells is greater than any threshold value configured by the base station.

The operations related to this are as shown in [Table 15] below.

TABLE 15
The UE shall:

| | |
|---|---|
| 1> | consider the entering condition for this event to be satisfied when condition A4-1, as |
| | specified below, is fulfilled; |
| 1> | consider the leaving condition for this event to be satisfied when condition A4-2, as |
| | specified below, is fulfilled. |

```
Inequality A4-1 (Entering condition)
Mn + Ofn + Ocn − Hys > Thresh
Inequality A4-2 (Leaving condition)
Mn + Ofn + Ocn + Hys < Thresh
The variables in the formula are defined as follows:
  Mn is the measurement result of the neighbouring cell, not taking into account any offsets.
  Ofn is the measurement object specific offset of the neighbour cell (i.e., offsetMO as
```

defined within measObjectNR corresponding to the neighbour cell).

Ocn is the measurement object specific offset of the neighbour cell (i.e.,

cellIndividualOffset as defined within measObjectNR corresponding to the neighbour
cell), and set to zero if not configured for the neighbour cell.

Hys is the hysteresis parameter for this event (i.e., hysteresis as defined within

reportConfigNR for this event).

Thresh is the threshold parameter for this event (i.e., a4-Threshold as defined within

reportConfigNR for this event).

```
  Mn is expressed in dBm in case of RSRP, or in dB in case of RSRQ and RS-SINR.
  Ofn, Ocn, Hys are expressed in dB.
  Thresh is expressed in the same unit as Mn.
```

Event A5 (SpCell becomes worse than threshold1 and neighbour becomes better than threshold2).

The terminal 7-02 may attempt measurement within the measurement frequency bands configured by the base station or within the neighboring cell list for measurement configured by the base station, and trigger CHO in case where the measurement value of the serving cell is less than any threshold value 1 configured by the base station, and the neighboring cell is greater than any threshold 2 configured by the base station.

The operations related to this are as shown in [Table 16] below.

TABLE 16
The UE shall:

| 1> | 1> | consider the entering condition for this event to be satisfied when both |
|---|---|---|
| | condition A5-1 and condition A5-2, as specified below, are fulfilled; | |
| 1> | 1> | consider the leaving condition for this event to be satisfied when condition |
| | A5-3 or condition A5-4, i.e., at least one of the two, as specified below, is fulfilled; | |
| 1> | 1> | use the SpCell for Mp. |
| | NOTE 1: | The parameters of the reference signal(s) of the cell(s) that triggers the event |

```
  are indicated in the measObjectNR associated to the event which may be different
  from the measObjectNR of the NR SpCell.
```

```
Inequality A5-1 (Entering condition 1)
Mp + Hys < Thresh1
Inequality A5-2 (Entering condition 2)
Mn + Ofn + Ocn − Hys > Thresh2
Inequality A5-3 (Leaving condition 1)
Mp − Hys > Thresh1
Inequality A5-4 (Leaving condition 2)
Mn + Ofn + Ocn + Hys < Thresh2
The variables in the formula are defined as follows:
  Mp is the measurement result of the NR SpCell, not taking into account any offsets.
  Mn is the measurement result of the neighbouring cell, not taking into account any offsets.
  Ofn is the measurement object specific offset of the neighbour cell (i.e., offsetMO as
```

defined within measObjectNR corresponding to the neighbour cell).

Ocn is the cell specific offset of the neighbour cell (i.e., cellIndividualOffset as defined

within measObjectNR corresponding to the neighbour cell), and set to zero if not
configured for the neighbour cell.

Hys is the hysteresis parameter for this event (i.e., hysteresis as defined within

reportConfigNR for this event).

Thresh1 is the threshold parameter for this event (i.e., a5-Threshold1 as defined within

reportConfigNR for this event).

Thresh2 is the threshold parameter for this event (i.e., a5-Threshold2 as defined within

reportConfigNR for this event).

```
  Mn, Mp are expressed in dBm in case of RSRP, or in dB in case of RSRQ and RS-SINR.
  Ofn, Ocn, Hys are expressed in dB.
  Thresh1is expressed in the same unit as Mp.
  Thresh2 is expressed in the same unit as Mn.
```

The serving cell base station 7-01 may configure the terminal 7-02 to trigger CHO, measurement for CHO, or evaluation for CHO in case where one or more of the above conditions are simultaneously satisfied.

Thereafter, the serving cell 7-01 may transmit an NES status information (or change) signal to the terminal 7-02 (S750).

The corresponding NES status information/change signal may be a signal including some or all of the following information:
Any NES status and/or pattern information (on/off duration, period, offset) of a serving cell;
NES status and/or pattern information (on/off duration, period, offset) of a neighboring cell;
NES activation/deactivation indicator of a serving cell;
NES activation/deactivation indicator of a neighboring cell;
NES pattern change indication of a serving cell;
NES pattern change indication of a neighboring cell;
Indicator to start CHO upon signal reception;
Target cell ID (PCI) to perform CHO upon signal reception; and/or
Candidate cell ID (PCI) or ID list that may perform CHO upon receiving a signal.

The signal may be an RRC message, MAC-CE message, or PHY DCI message.

The signal may include some or all of the information such as the ID of each cell (physical cell ID (PCI)), each NES mode ID (NES indicator), and each pattern ID (pattern ID).

The terminal 7-02 performs the necessary measurements and judgments to determine whether to perform CHO based on the CHO configuration information received from the serving cell 7-01 in S740 and the NES status (change) information received in S750 (S760).

For example, when the terminal 7-02 receives the DTX activation signal of the serving cell from the serving cell base station 7-01, the terminal 7-02 may identify the DTX operation pattern of the corresponding serving cell 7-01 and be configured to perform CHO when the serving cell transitions to the DTX mode according to the pattern (S740). Accordingly, after receiving the DTX activation signal of the serving cell (S750), the terminal may identify the NES operation information of the serving cell included in any previously received RRC signal (RRC reconfiguration signal), RRC signal (S740) including CHO configuration information for performing CHO, or DTX activation signal (S750) of the serving cell, for example, the DTX on/off duration length and period of the serving cell, and the DTX transition point of the serving cell obtained by substituting the offset into the current radio frame (S760).

In another embodiment, the terminal 7-02 may be configured by the base station 7-01 to perform CHO to a corresponding cell (S740) when the conditions for the serving cell to start NES operation are satisfied at the same time that there is a neighboring cell with a cell measurement value higher than or equal to a certain threshold (A4 event). In this case, the terminal 7-02 receives the DTX activation signal of the serving cell, identifies the DTX transition point of the serving cell, and evaluates whether there is a neighboring cell that satisfies the A4 event at that time (S760). In case where there is a corresponding neighboring cell (S770), the terminal may transmit a random access preamble through the PRACH resource preconfigured to the corresponding neighboring cell, and perform CHO, such as starting the RACH operation (S780).

In an embodiment, when the terminal 7-02 receives the DTX activation signal of the serving cell from the serving cell base station 7-01, the terminal 7-02 may identify the DTX operation pattern of the serving cell and be configured to perform CHO when the serving cell transitions to the DTX mode according to the pattern (S740). Accordingly, after receiving the DTX activation signal of the serving cell (S750), the terminal may identify the DTX transition time of the serving cell (S760), and perform CHO (S780) when the serving cell transition time comes (S770). Through the corresponding configuration and operation, the terminal 7-02 may use the NES configuration information not only to identify the NES operation and operation timing of the cell, but also to determine any trigger conditions for performing CHO.

In another embodiment, the base station 7-01 may include in a corresponding event an indicator that allows the terminal to know that the corresponding event is performed in case where the serving cell enters the NES mode, or may configure a signal that is bundled with the corresponding event and configured to the terminal (S740), while configuring CHO performance trigger conditions for the terminal 7-02 according to measurements of a certain serving cell and neighboring cell (e.g., A3, A4, A5 events). In this case, the terminal 7-02 may identify the DTX transition point of the serving cell through any signal for which the serving cell has previously configure NES or a newly received DTX activation signal, and at the same time evaluate whether there is a neighboring cell that satisfies the CHO conditions through measurements configured at the corresponding time (S760), and perform CHO, such as starting RACH operation by transmitting a random access preamble through a PRACH resource preconfigured to the corresponding neighboring cell (S780) in case where the corresponding neighboring cell exists (S770).

In still another embodiment, the base station 7-01 may include in a corresponding event an indicator that allows the terminal to know that the corresponding event is performed in case where the serving cell enters the NES mode, and an indicator that triggers CHO when the DTX/DRX activation signal of the serving cell transmitted from the serving cell is next received in the corresponding event, or may configure a signal that is bundled with the corresponding event and configured to the terminal (S740), while configuring CHO performance trigger conditions for the terminal 7-02 according to measurements of a certain serving cell and neighboring cell (e.g., A3, A4, A5 events). In this case, the terminal 7-02 may identify the DTX transition point of the serving cell after newly receiving the DTX activation signal, and at the same time evaluate whether there is a neighboring cell that satisfies the CHO conditions through measurements configured at the corresponding time (S760), and perform CHO, such as starting RACH operation by transmitting a random access preamble through a PRACH resource preconfigured to the corresponding neighboring cell (S780) in case where the corresponding neighboring cell exists (S770).

An indicator (first indicator) that allows the terminal to know that the corresponding event is performed when the serving cell enters the NES mode, and an indicator (second indicator) that triggers CHO when receiving the DTX/DRX activation signal of the serving cell transmitted next from the serving cell may be different indicators, and the first indicator and the second indicator may be configured as one indicator that indicates both operations of information provision and CHO trigger.

In an embodiment, the terminal 7-02 may know from the serving cell base station 7-01 in advance through the standard that the terminal may perform CHO if the DTX activation signal of the serving cell includes an indicator that CHO may be performed. Accordingly, after receiving the DTX activation signal of the serving cell (S750), the terminal 7-02 identifies that there is an indicator that CHO may be performed in the signal, and may perform CHO (S760 to S780). Through the corresponding configurations and operations, the terminal 7-02 may use the NES configuration information not only to identify the NES operation of the cell and operation timing, but also to determine any trigger conditions for performing CHO.

In an embodiment, the terminal 7-02 may know from the serving cell base station 7-01 in advance through the standard that the terminal may identify the DTX operation pattern of the corresponding serving cell and perform CHO when the serving cell transitions to the DTX mode according to a pattern if the DTX activation signal of the serving cell includes an indicator that CHO may be performed. Accordingly, after receiving the DTX activation signal of the serving cell (S750), the terminal 7-02 may identify the DTX transition time of the serving cell (S760), and perform CHO (S780) when the transition time of the serving cell arrives (S770). Through the corresponding configurations and operations, the terminal 7-02 may use the NES configuration information not only to identify the NES operation of the cell and operation timing, but also to determine any trigger conditions for performing CHO.

In an embodiment, the terminal 7-02 may be configured to perform CHO upon receiving the DTX activation signal of the serving cell from the serving cell base station 7-01 (S740). Accordingly, after receiving the DTX activation signal of the serving cell (S750), the terminal may perform CHO (S760 to S780). Through the corresponding configurations and operations, the terminal may use the NES configuration information not only to identify the NES operation of the cell and operation timing, but also to determine any trigger conditions for performing CHO.

In an embodiment, when the terminal 7-02 receives the DTX activation signal of the serving cell from the serving cell base station 7-01, the terminal 7-02 may identify the DTX operation pattern of the serving cell and be configured to perform CHO when the serving cell transitions to the DTX mode according to the pattern (S740). Accordingly, after receiving the DTX activation signal of the serving cell (S750), the terminal may identify the DTX transition time of the serving cell (S760), and perform CHO (S780) when the serving cell transition time arrives (S770). Through the corresponding configurations and operations, the terminal may use the NES configuration information not only to identify the NES operation of the cell and operation timing, but also to determine any trigger conditions for performing CHO.

In the various embodiments above, any signal (S7-07, 7-08) through which the serving cell 7-01 transmits information to the terminal 7-02 in S740 and S750 may be any signal transmitted as a cast type of Unicast, Groupcast, or Multicast, for example, any one of an RRC signal such as RRCReconfig, a MAC signal such as MAC CE, and a PHY signal such as downlink control information (DCI), etc.

In addition, in S760, the serving cell 7-01 may combine the NES status/change information of the serving cell 7-01 or neighboring cells 7-03 with the CHO configuration information and transmit one message to the terminal by including the same in, for example, an RRC reconfiguration message or a MAC-CE message. In the above-described embodiment of FIG. 7, the operations of the disclosure are described by specifying the terms of the DTX activation signal and DTX operation pattern for convenience of explanation, but the embodiment of the disclosure is not limited thereto. In other words, the above-described operations may be equally applied to, for example, operations in case where DRX or NES is activated. In this case, in the above-mentioned examples, it is obvious to those skilled in the art that a DRX activation signal or a NES activation signal may be substituted for the DTX activation signal, respectively. In addition, although the DRX activation signal has been specified, it is obvious that it applies to the case of deactivation, not the case of activation.

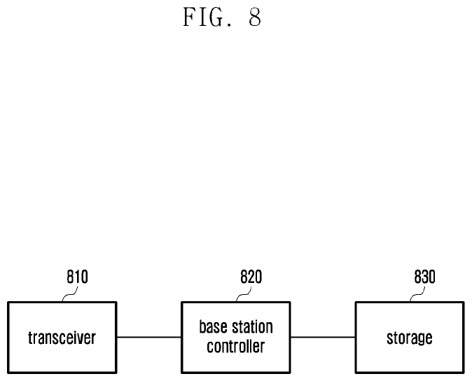

FIG. 8 illustrates a structure of a base station according to an embodiment of the present disclosure.

With reference to FIG. 8, the base station may include a transceiver 810, a controller 820, and a storage 830. The transceiver 810, the controller 820, and the storage 830 may operate according to a communication method of the base station as described above. In addition, a network device may correspond to the structure of the base station. However, components of the base station are not limited to the above-mentioned components. For example, the base station may include more or less components that those mentioned above. For example, the base station may include the transceiver 810 and the controller 820. Further, the transceiver 810, the controller 820, and the storage 830 may be implemented in a form of a single chip.

The transceiver 810 is collectively referred to as a receiver of the base station and a transmitter of the base station, and may transmit signals to or receive signals from the terminal, another base station or other network entities. In this case, the signals transmitted to or received may include control information and data. For example, the transceiver 810 may transmit system information to the terminal and may transmit a synchronization signal or a reference signal. To this end, the transceiver 810 may include an RF transmitter for up-converting and amplifying the frequency of a signal to be transmitted, and an RF receiver for low-noise amplifying a received signal and down-converting a frequency of the received signal. However, this is merely an example of the transceiver 810, and elements of the transceiver 810 are not limited to an RF transmitter and an RF receiver. The transceiver may include a wired/wireless transceiver, and may include various constitution for transmitting and receiving signals. Further, the transceiver 810 may receive signals via a communication channel (e.g., wireless channel) and output signals to the controller, and may transmit signals output from the controller via a communication channel. Further, the transceiver 810 may receive and output a communication signal to a processor, and may transmit the signal output from the processor to a terminal, another base station, another network entity via a wired/wireless network.

The storage 830 may store programs and data required for operations of the base station. Also, the storage 830 may store control information or data included in a signal acquired by the base station. Also, the storage 830 may be constituted with storage media, such as ROM, RAM, a hard disc, CD-ROM, and a DVD, or a combination of the storage media. Also, the storage 830 may store at least one of information transmitted/received through the transceiver 810, and information generated by the controller 820.

In the present disclosure, the controller 820 may be defined as a circuit, an application specific integrated circuit, or at least one processor. The processor may include a communication processor (CP) that performs control for communication and an application processor (AP) that controls upper layers such as application programs. The controller 820 may control overall operations of the base station according to the embodiments provided in the disclosure. For example, the controller 820 may control a signal flow between blocks to perform operations according to the flowchart described above.

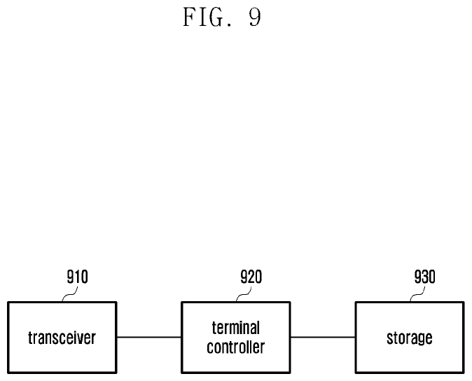

FIG. 9 illustrates a structure of a terminal according to an embodiment of the present disclosure.

With reference to FIG. 9, the terminal may include a transceiver 910, a controller 920, and a storage 930. The transceiver 910, controller 920, and storage 930 may operate according to a communication method of the terminal as described above. However, components of the terminal are not limited to the above-mentioned components. For example, the terminal may include more or less components that those mentioned above. For example, the terminal may include the transceiver 910 and the controller 920. Further, the transceiver 910, controller 920, and storage 930 may be implemented in a form of a single chip.

The transceiver 910 is collectively referred to as a receiver of the terminal and a transmitter of the terminal, and may transmit signals to or receive signals from the base station, another terminal or network entities. The signals transmitted and received from the base station may include control information and data. For example, the transceiver 910 may receive system information from the base station and may receive a synchronization signal or a reference signal. To do this, the transceiver 910 may include an RF transmitter for up-converting a frequency of a signal to be transmitted and amplifying the signal, and an RF receiver for low-noise amplifying a received signal and down-converting a frequency of the received signal. However, this is only an embodiment of the transceiver 910, and the components of the transceiver 910 are not limited to the RF transmitter and RF receiver. Also, the transceiver may include a wired/wireless transceiver, and may include various constitution for transmitting and receiving signals. Further, the transceiver 910 may receive signals via a wireless channel and output signals to the controller, and may transmit signals output from the controller 920 via a wireless channel. Further, the transceiver 910 may receive and output a communication signal to a processor, and may transmit the signal output from the processor to a network entity via a wired/wireless network.

The storage 930 may store programs and data required for operations of the terminal. Also, the memory may store control information or data included in a signal acquired by the terminal. The storage 930 may be constituted with storage media, such as ROM, RAM, a hard disc, CD-ROM, and a DVD, or a combination of the storage media.

In the present disclosure, the controller 920 may be defined as a circuit, an application specific integrated circuit, or at least one processor. The processor may include a communication processor (CP) that performs control for communication and an application processor (AP) that controls upper layers such as application programs. The controller 920 may control overall operations of the terminal according to the embodiments provided in the disclosure. For example, the controller 920 may control a signal flow between blocks to perform operations according to the flowchart described above.

Methods according to the embodiments disclosed in the claims or specification of the disclosure may be implemented by hardware, software, or a combination of hardware and software.

In case where the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments disclosed in the claims or specification of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory constructed with any combination of some or all of them. In addition, a plurality of respective constituent memories may be included.

In addition, the programs may be stored in an attachable storage device which may access the electronic device through communication networks constituted with a communication network such as the Internet, Intranet, local area network (LAN), wide local area network (WLAN), and storage area network (SAN) or a combination thereof. Such a storage device may access the electronic device performing the embodiments of the disclosure via an external port. Further, a separate storage device on the communication network may access a device performing the embodiments of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information for a conditional handover (CHO) including trigger condition information for the CHO;
identifying whether the trigger condition information includes information indicating that an event for a trigger condition is associated with network energy saving (NES);
in case that the trigger condition information includes the information, identifying whether an indication for a NES mode is received from the base station;
in case that the indication for the NES mode is received, identifying whether the event for the trigger condition is satisfied based on a reception of the indication; and
in case that the event for the trigger condition is satisfied, performing a CHO procedure.

2. The method of claim 1, wherein the configuration information for the CHO is received via a radio resource control (RRC) message,
wherein the indication for the NES mode is received via a downlink control information (DCI), and
wherein the event for the trigger condition is associated with a specific NES mode.

3. The method of claim 2, wherein the specific NES mode includes a first mode that a serving cell goes into a discontinuous transmission (DTX) or a discontinuous reception (DRX), or a second mode that a candidate cell comes out of the DTX or the DRX.

4. The method of claim 1, further comprising:
receiving, from the base station, NES mode status information associated with a serving cell and a candidate cell,
wherein the NES mode status information includes at least one of information on a cell identity (ID), information on a NES mode for a corresponding cell, or information on a NES mode operation state for the corresponding cell.

5. The method of claim 1, further comprising:
transmitting, to the base station, capability information indicating that the terminal supports the CHO,
wherein the configuration information for the CHO is received based on the capability information, and
wherein, in case that trigger condition information does not include the information, an evaluation for the event is performed based on a reception of the configuration information for the CHO.

6. A method performed by a base station in a wireless communication system, the method comprising:
transmitting, to a terminal, configuration information for a conditional handover (CHO) including trigger condition information for the CHO; and
in case that the trigger condition information includes information indicating that an event for a trigger condition is associated with network energy saving (NES), transmitting, to the terminal, an indication for a NES mode,
wherein whether the event for the trigger condition is satisfied is identified based on the indication, and
wherein, in case that the event for the trigger condition is satisfied, a CHO procedure is performed.

7. The method of claim 6, wherein the configuration information for the CHO is transmitted via a radio resource control (RRC) message,
wherein the indication for the NES mode is transmitted via a downlink control information (DCI), and
wherein the event for the trigger condition is associated with a specific NES mode.

8. The method of claim 6, wherein the specific NES mode includes a first mode that a serving cell goes into a discontinuous transmission (DTX) or a discontinuous reception (DRX), or a second mode that a candidate cell comes out of the DTX or the DRX.

9. The method of claim 6, further comprising:
obtaining, from a candidate cell, information on a NES mode status for the candidate cell; and
transmitting, to the terminal, NES mode status information associated with a serving cell of the base station and the candidate cell based on the information on the NES mode status for the candidate cell,
wherein the NES mode status information includes at least one of information on a cell identity (ID), information on a NES mode for a corresponding cell, or information on a NES mode operation state for the corresponding cell.

10. The method of claim 6, further comprising:
receiving, from the terminal, capability information indicating that the terminal supports the CHO,
wherein the configuration information for the CHO is transmitted based on the capability information, and
wherein, in case that trigger condition information does not include the information, an evaluation for the event is performed based on the configuration information for the CHO.

11. A terminal in a wireless communication system, the terminal comprising:
a transceiver; and
a controller configured to:
control the transceiver to receive, from a base station, configuration information for a conditional handover (CHO) including trigger condition information for the CHO,
identify whether the trigger condition information includes information indicating that an event for a trigger condition is associated with network energy saving (NES),
in case that the trigger condition information includes the information, identify whether an indication for a NES mode is received from the base station,
in case that the indication for the NES mode is received, identify whether the event for the trigger condition is satisfied based on a reception of the indication, and
in case that the event for the trigger condition is satisfied, perform a CHO procedure.

12. The terminal of claim 11, wherein the configuration information for the CHO is received via a radio resource control (RRC) message,
wherein the indication for the NES mode is received via a downlink control information (DCI), and
wherein the event for the trigger condition is associated with a specific NES mode.

13. The terminal of claim 12, wherein the specific NES mode includes a first mode that a serving cell goes into a discontinuous transmission (DTX) or a discontinuous reception (DRX), or a second mode that a candidate cell comes out of the DTX or the DRX.

14. The terminal of claim 11, wherein the controller is further configured to control the transceiver to receive, from the base station, NES mode status information associated with a serving cell and a candidate cell, and
wherein the NES mode status information includes at least one of information on a cell identity (ID), information on a NES mode for a corresponding cell, or information on a NES mode operation state for the corresponding cell.

15. The terminal of claim 11, wherein the controller is further configured to control the transceiver to transmit, to the base station, capability information indicating that the terminal supports the CHO,
wherein the configuration information for the CHO is received based on the capability information, and
wherein, in case that trigger condition information does not include the information, an evaluation for the event is performed based on a reception of the configuration information for the CHO.

16. A base station in a wireless communication system, the base station comprising:
a transceiver; and
a controller configured to:
control the transceiver to transmit, to a terminal, configuration information for a conditional handover (CHO) including trigger condition information for the CHO, and
in case that the trigger condition information includes information indicating that an event for a trigger condition is associated with network energy saving (NES), control the transceiver to transmit, to the terminal, an indication for a NES mode,
wherein whether the event for the trigger condition is satisfied is identified based on the indication, and
wherein, in case that the event for the trigger condition is satisfied, a CHO procedure is performed.

17. The base station of claim 16, wherein the configuration information for the CHO is transmitted via a radio resource control (RRC) message,
wherein the indication for the NES mode is transmitted via a downlink control information (DCI), and
wherein the event for the trigger condition is associated with a specific NES mode.

18. The base station of claim 16, wherein the specific NES mode includes a first mode that a serving cell goes into a discontinuous transmission (DTX) or a discontinuous reception (DRX), or a second mode that a candidate cell comes out of the DTX or the DRX.

19. The base station of claim 16, wherein the controller is further configured to obtain, from a candidate cell, information on a NES mode status for the candidate cell, and control the transceiver to transmit, to the terminal, NES mode status information associated with a serving cell of the base station and the candidate cell based on the information on the NES mode status for the candidate cell, and
wherein the NES mode status information includes at least one of information on a cell identity (ID), information on a NES mode for a corresponding cell, or information on a NES mode operation state for the corresponding cell.

20. The base station of claim 16, wherein the controller is further configured to control the transceiver to receive, from the terminal, capability information indicating that the terminal supports the CHO,
wherein the configuration information for the CHO is transmitted based on the capability information, and
wherein, in case that trigger condition information does not include the information, an evaluation for the event is performed based on the configuration information for the CHO.
